(19) United States
(12) Patent Application Publication
(10) Pub. No.: US 2009/0158178 A1
(43) Pub. Date: Jun. 18, 2009

(54) GRAPHICALLY NAVIGATING TREE STRUCTURES

(76) Inventors: DORIAN BIRSAN, Toronto (CA); Valentina Birsan, Toronto (CA)

Correspondence Address: IBM CORP (YA);C/O YEE & ASSOCIATES PC, P.O. BOX 802333, DALLAS, TX, 75380, US

(21) Appl. No.: 11/958,309

(22) Filed: Dec. 17, 2007

(51) Int. Cl. G06F 3/00

(52) U.S. Cl. 715/762

(57) ABSTRACT

Illustrative embodiments provide a computer implemented method, an apparatus and a computer program product for graphically navigating tree structures. In one illustrative embodiment, the computer implemented method comprises creating an outliner view of a tree view comprising the entire tree structure and determining whether an object has been selected from the tree view to create a selected object. The computer implemented method further, responsive to a determination that the object was selected, displays the entire tree view and further displays the selected object only, in a legible form, in the outliner view.

### BACKGROUND OF THE INVENTION

1. Field of the Invention

The present invention relates generally to an improved data processing system, and in particular to a computer implemented method, an apparatus and a computer program product for graphically navigating tree structures.

2. Description of the Related Art

In conventional systems, data is usually represented by using a tree structure. A tree is a hierarchical structure that shows the relationship of one object with another. Each object is represented as a part in the tree. A user can access an object that is contained by another object by drilling down to that object in the tree structure. Drilling down means to move to or view lower levels in the hierarchical structure. For example, in a file directory using the tree analogy, the directory structure may be displayed as a tree indicating the various levels from the main or root directory through sub-directories or branches down to the individual files or leaves. In a similar manner, a network and related resources may be viewed.

However, in conventional systems, data displayed by a tree view can be overwhelming. Some objects in a tree that are frequently used by some users are contained under a complex tree structure. To select a desired object, the user has to scroll to the corresponding parent object and then expand this object until the desired object is made visible. For large tree structures this operation can be extremely slow.

For large trees, it is also hard to understand the tree's complete structure since the tree is too large to be viewed on the current display. The entire content of the tree cannot be seen in the tree view window. A known solution uses display scrolling with scroll bars to scroll the tree and expand the selected item. This known solution is not ideal as it does not scale for large trees where the operation of the known solution becomes slow and awkward. The user is unable to see the entire tree content at once and typically becomes lost. Further, frustration is added because multiple mouse selections are required when using the scroll bar and expand mechanism to locate an object in the tree. There is a need to more efficiently view a large tree structure and navigate to a desired object.

### SUMMARY OF THE INVENTION

Illustrative embodiments provide a computer implemented method, an apparatus in the form of a data processing system, and a computer program product for graphically navigating tree structures. In one illustrative embodiment, the computer implemented method comprises creating an outliner view of a tree view comprising the entire tree structure and determining whether an object has been selected from the tree view to create a selected object. The computer implemented method further responsive to a determination that the object was selected, displays the entire tree view and further displays the selected object only in a legible form in the outliner view.

In another illustrative embodiment, a data processing system comprises a bus, a memory connected to the bus, a display connected to the bus, a communications unit connected to the bus, a persistent storage connected to the bus, wherein the persistent storage has computer usable instructions tangibly embodied thereon, a processor unit connected to the bus, wherein the processor unit executes the computer program instructions to create an outliner view of a tree view comprising the entire tree structure, and determine whether an object has been selected from the tree view to create a selected object. The processor unit further executes the computer program instructions to respond to a determination that the object was selected and display the entire tree view and further display the selected object only in a legible form in the outliner view, otherwise, display a current portion of the entire tree view in the outliner view.

In another illustrative embodiment, a computer program product comprising a computer usable recordable medium having computer usable program code tangibly embodied thereon, the computer usable program code comprises computer usable program code for creating an outliner view of a tree view comprising the entire tree structure and computer usable program code for determining whether an object has been selected from the tree view to create a selected object. The computer usable program code further comprises computer usable program code, responsive to an object being selected, for displaying the entire tree view and further displaying the selected object only, in a legible form, in the outliner view; otherwise, displaying a current portion of the entire tree view in the outliner view.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 is a block diagram of a data processing system in which illustrative embodiments may be implemented;

FIG. 3 is a block diagram of a portion of an outliner in accordance with illustrative embodiments;

FIG. 4 is a textual representation of conventional tree view of a file structure, in accordance with illustrative embodiments;

FIG. 5 is a textual representation of an outliner view of the tree view of FIG. 4 in accordance with illustrative embodiments;

FIG. 6 is a textual representation of an outliner view of FIG. 5, with a cursor over an object, in accordance with illustrative embodiments;

FIG. 7 is a textual representation of an outliner view of FIG. 5, with an object selected, in accordance with illustrative embodiments;

FIG. 8 is a flowchart of the outliner process in accordance with illustrative embodiments.

### DETAILED DESCRIPTION OF THE PREFERRED EMBODIMENT

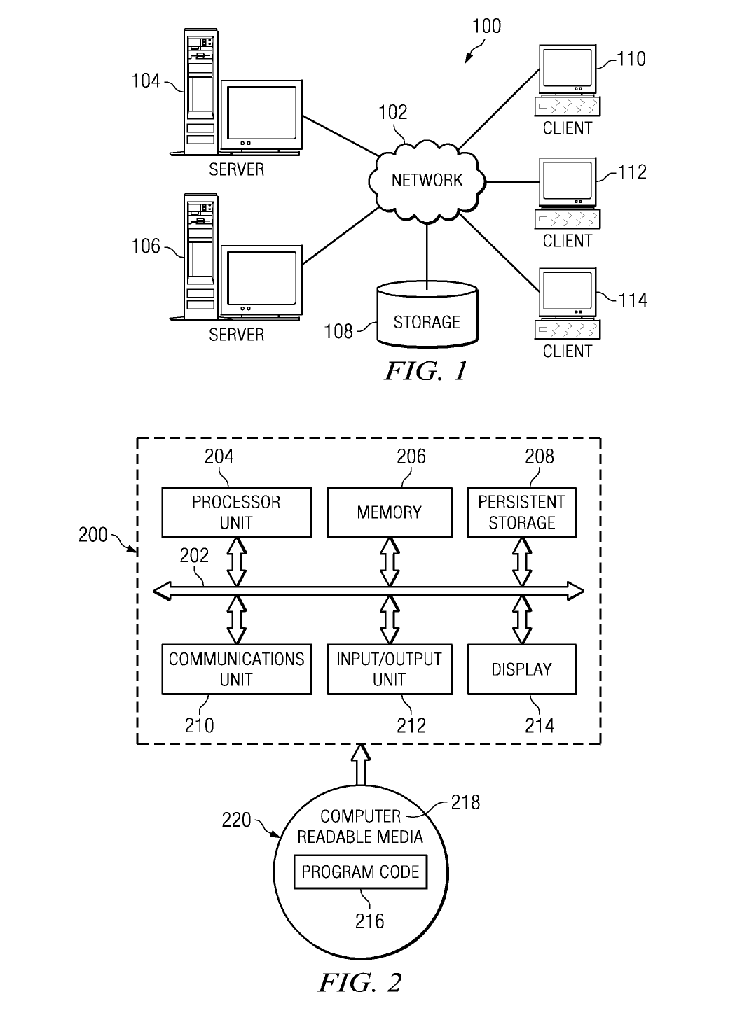

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

In illustrative embodiments, an outliner provides a capability to graphically navigate the entire tree structure efficiently. In an illustrative embodiment an outliner may be implemented as a browser extension on a client, while in another the outliner may be implemented as a web service or applet, accessed and used from a server when needed. In another illustrative embodiment an outliner may be implemented as part of a file system manager and viewer. For example, a user on client 110 may wish to process a set of files contained on server 106 through network 102 of FIG. 1. The outliner allows the user, on client 110, to quickly navigate the tree structure representation of the file system on server 106, with only one mouse selection. The user has only to move the mouse over a portion of the view and that portion of the tree is automatically expanded and made legible.

The outliner provides a graphical view that represents an overview of the tree structure. The graphical view allows the user to visualize the entire tree structure, see where the selection is made within the tree and navigate the tree structure by using a mouse selection.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub that may be present in communications fabric 202.

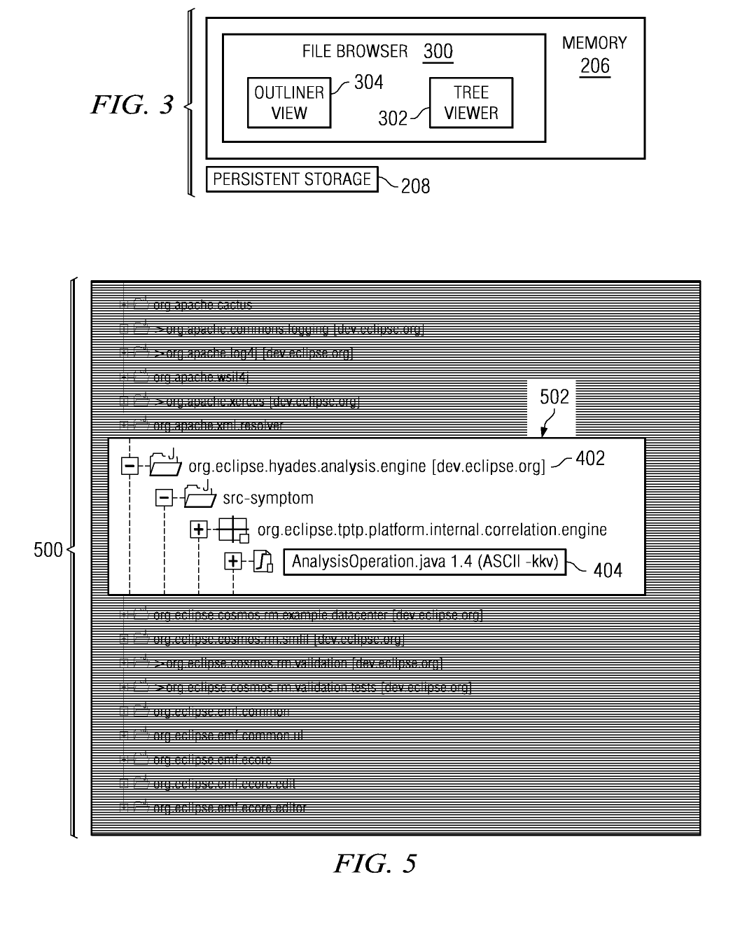

With reference to FIG. 3, a block diagram of a portion of an outliner, in accordance with illustrative embodiments is shown. An outliner is a graphical view which represents an overview of the tree and allows the user to visualize the entire tree structure. As seen in FIG. 2, components of a file browser 300 are in memory 206 as previously shown in system 200 of FIG. 2.

File browser 300 provides the capability to access and view elements of the file system as may be found on persistent storage 208 of FIG. 2. Typically, file browser 300 uses tree view 302 to visualize the content of the file system. For example tree viewer 302, when requested, would cause the content of the file system to be displayed in a tree structure format. Tree viewer 302 renders the file system content in a convention manner typically seen in the form of a hierarchy of directory entries. The hierarchy of directory entries flows from the root or main directory to list various subdirectories and files of the main directory.

Outliner viewer 304 works with tree view 302 in the viewing of the file system entries. Outliner viewer 304 makes the entire tree view of the directory structure visible, while focusing on a small relevant portion within the structure to make that portion legible or readable to a user. The area of focus allows objects within the structure to be zoomed by a mouse over operation or to be selectively expanded to show a sub-tree structure within the structure. These examples of functional elements are illustrative and not intended to be limiting on the manner or the location in which an implementation of viewer components is made. For example, as stated previously outliner view 304 may be implemented in a variety of ways including as a portion of tree view 302.

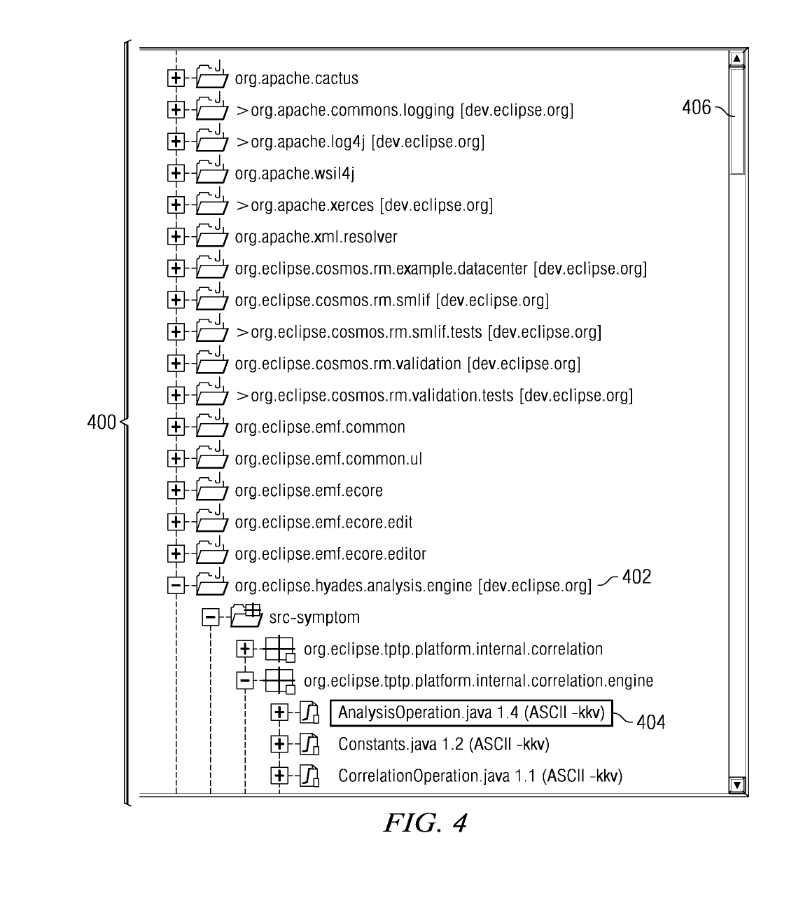

With reference to FIG. 4, a textual representation of a conventional tree view of a file structure is shown. The exemplary view represents a hierarchical file directory structure as may typically be generated by tree view 302 and rendered in a view showing the file directory. This typical view is commonly used to show the relationships between the various levels of a directory. Tree view 400 is shown as a typical view of a file system structure listing contents in the form of a hierarchy of subdirectories. Each element of the view is legible, which means, in this case, able to be read by the user, as a line of text with associated graphic figures. For example, element 402 is a subdirectory that has been expanded to expose the content within, while element 404 is an object that has been highlighted within the tree view.

In the example of FIG. 4, a portion of the tree is shown, while most of the tree structure cannot be displayed due to the number of entries and therefore the size of the structure. The scroll bar 406, on the right side of the display, is visible to allow the user to move within the file structure.

With reference to FIG. 5, a textual representation of an outliner view of tree view 400 of FIG. 4, in accordance with illustrative embodiments is shown. Outliner view 500, as may be generated by an illustrative embodiment of outliner view 304 of FIG. 3, is an enhanced representation of tree view 400 of FIG. 4, in which the whole tree structure may be seen at once. Outliner view 500 displays the entire tree structure in contrast to the partial tree structure of tree view 400. While the entire tree structure is portrayed in outliner view 500, the entire content is not legible. In this case while the content is visible it is not entirely legible to the user. Outliner view 500 presents the entire tree structure in a visible manner allowing the user to recognize content and major areas of the structure but does not present the entire structure in detail. A view port 502 is defined by a rectangular area in which the text entries for the file system elements are made visible and legible, now being able to be read by the user. View port 502 defines a current focus area within the complete tree structure. The focus area was determined by the selection of an object from within the tree view of FIG. 4.

For example, within view port 502 is shown element 402 of FIG. 4. Element 402 is the root or parent of the selected object that is element 404 of FIG. 4. The object, element 404, was selected in tree view 400. While the entire tree is shown in the outliner view 500, only the selected object and the path to the object's root parent is made visible and legible or readable for the user within view port 502.

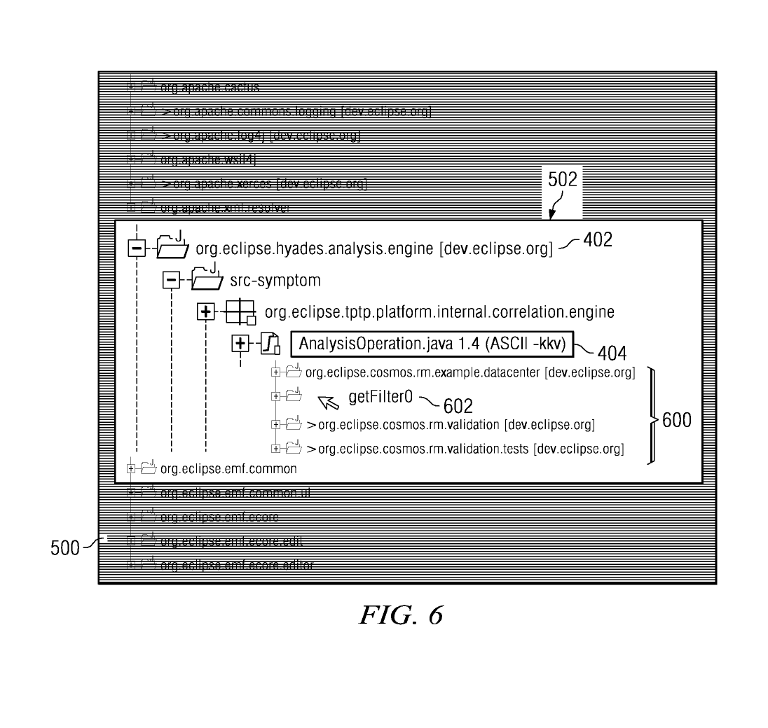

With reference to FIG. 6, a textual representation of the outliner view of FIG. 5, with a cursor over an object, in accordance with illustrative embodiments is shown. When a cursor, or mouse pointer, is moved over a specific portion of a tree within the outliner view, the rendering of that portion is changed. The specific portion of the tree is expanded to show increased detail one level down. The portion of the tree is highlighted and zoomed or enlarged to be legible allowing the user to read the text or visualize the image of the tree for the object under the mouse pointer.

For example, within view port 502 of outliner view 500 is shown the parent, element 402 and highlighted entry, element 404 from FIG. 4. Moving the mouse pointer over element 402 causes the element to expand revealing further detail in element 600 comprising text entries. The expanded entries, while present, are not legible. Moving the mouse pointer over element 602, for example, renders that object visible, or legible, in the outliner view.

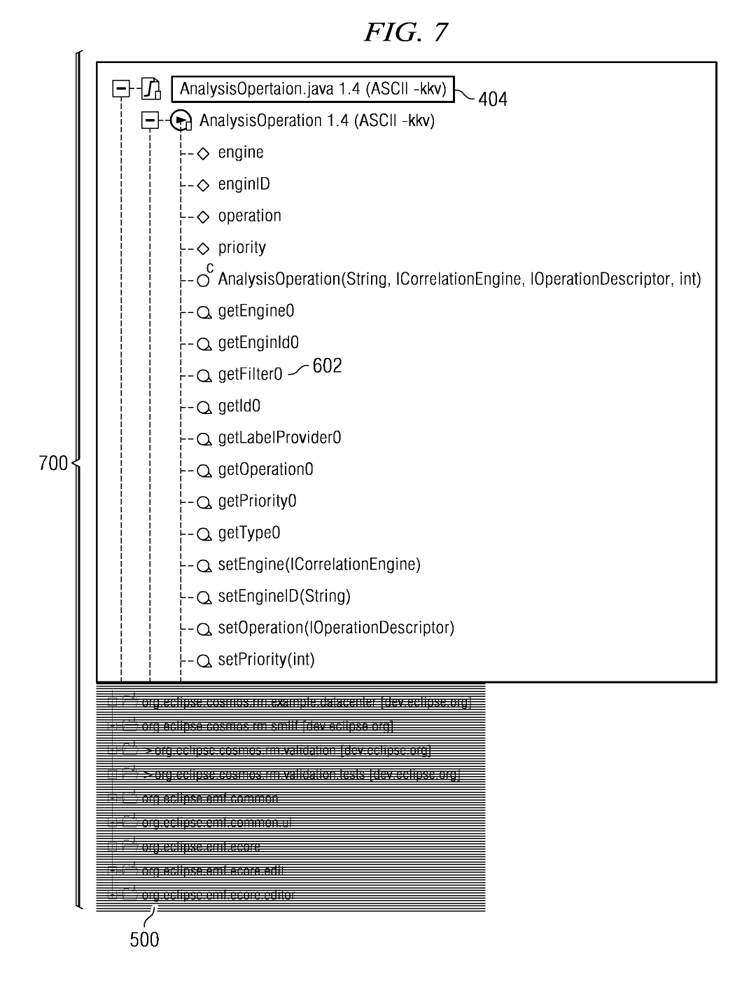

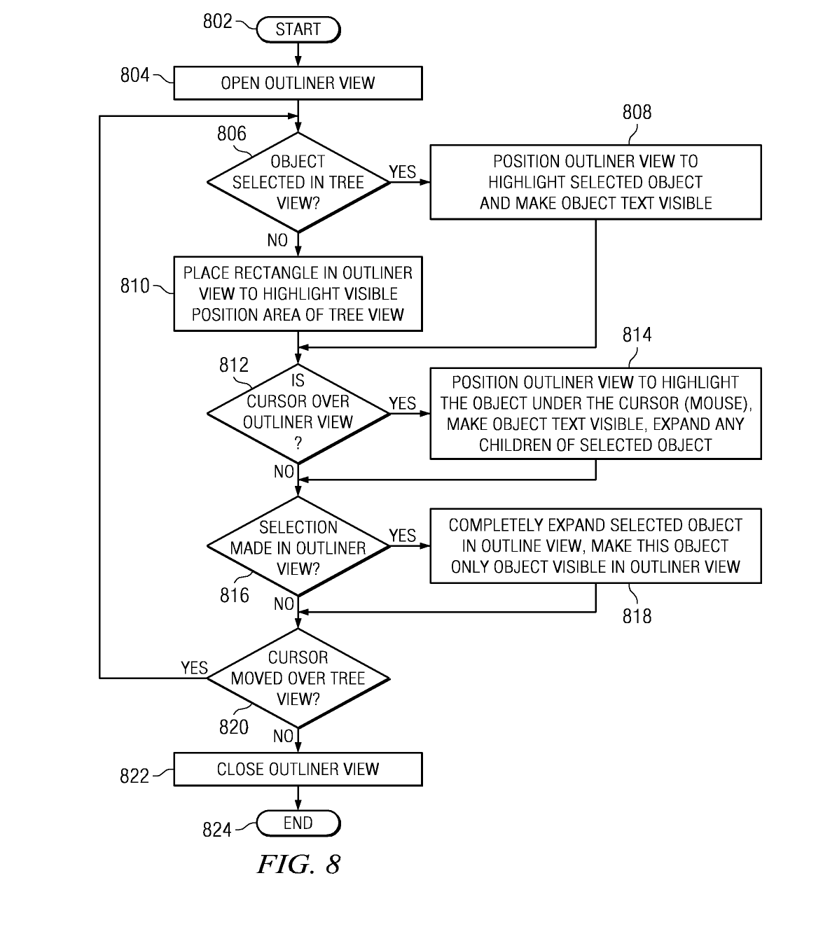

With reference to FIG. 7, a textual representation of an outliner view of FIG. 6, with an object selected, in accordance with illustrative embodiments is shown. Within the tree structure of outliner view 500, element 506 is further selected. Selecting or clicking the element of the tree structure in the outliner view results in the expansion of the element's sub-tree structure. The expanded element 700 now becomes the only tree structure portion visible within the outliner view, having all text entries legible. When compared with FIG. 6 in which only the mouse over of element 602 causes element 602 to be legible, and all similar entries under parent element 404 of FIG. 4 comprising expanded element 700 are now visible.

With reference to FIG. 8, a flowchart of the outliner process in accordance with illustrative embodiments is shown. Process 800 is an example of an outliner view process, such as that used in an illustrative embodiment of outliner viewer 304 of file browser 300 of FIG. 3.

Process 800 starts, assuming existence of a tree view is present (step 802), and opens an outliner view (step 804). A determination is made as to whether an object has been selected in the entire tree view (step 806). If an abject is selected, a “yes” is returned in step 806 otherwise a “no” results.

If a “yes” was obtained in step 806, position the outliner view to highlight the selected object and make the text entries for the object visible (step 808). If a “no” was obtained in step 806, or step 808 completed, place the view port rectangle in the outliner view to highlight a visible portion of the respective entire tree view (step 810). In the absence of a specific selection of an object in the tree view, the outliner view would default to a portion of the currently displayed entire tree view.

A determination is then made whether the cursor, or mouse pointer, is over an object within the outliner view port space (step 812). If a “yes” results, then the outliner view is positioned to highlight the object currently under the cursor, or mouse pointer, and makes the text entry for the object visible (step 814). Further, expansion is performed to reveal any children of the highlighted object.

If a “no” was obtained in step 812, or step 814 completed, process 800 determines whether an object selection has been made (step 816). If a “yes” was obtained in step 816, the selected object is completely expanded in the outliner view to reveal the contents (step 818). In addition, the selected object is made the only object visible in the outliner view. If a “no” was obtained in step 816, or step 818 completed, process 800 determines whether the cursor, or mouse pointer, has moved over the tree view (step 820). If a “yes” is obtained in step 820, process 800 loops back to step 806 to determine whether an object in the entire tree view has been selected, and process 800 continues as previously described. If a “no” was obtained in step 820, the outliner view is closed (step 822), and process 800 terminates thereafter (step 824).

Thus, the illustrative embodiments provide a capability enabling a user to navigate the hierarchical structure of the entire tree view, while seeing the entire tree content at once, further allowing the user to quickly navigate the tree with only a mouse selection. The user has only to move the mouse pointer over a portion of the entire tree view and the hidden tree structure is automatically expanded and made visible based on the cursor, or mouse pointer, position. Further selection of an object makes that object and its child elements the only point of focus in the outliner view.

The invention can take the form of an entirely hardware embodiment, an entirely software embodiment or an embodiment containing both hardware and software elements. In a preferred embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable recordable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for graphically navigating a tree structure, the computer implemented method comprising:
creating an outliner view of a tree view comprising the entire tree structure;
determining whether an object has been selected from the tree view to create a selected object;
responsive to a determination that the object was selected, displaying the entire tree view and further displaying the selected object only, in a legible form, in the outliner view.

2. The computer implemented method of claim 1, wherein displaying the entire tree view further comprises:
displaying a current portion of the entire tree view in the outliner view in the absence of the selected object.

3. The computer implemented method of claim 1, wherein displaying the selected object further comprises:
highlighting the selected object.

4. The computer implemented method of claim 1, wherein displaying the selected object further comprises:
displaying a path from the selected object to a parent of the selected object in a legible form in the outliner view.

5. The computer implemented method of claim 1, wherein displaying a current portion of the entire tree view in the outliner view further comprises:
navigating within the entire tree view by moving a mouse pointer; and
expanding an object when a mouse pointer moves over the object to reveal hidden associated objects.

6. The computer implemented method of claim 1, wherein displaying a current portion of the entire tree view in the outliner view further comprises:
displaying an object, when a mouse pointer moves over the object, in a legible form in the outliner view.

7. The computer implemented method of claim 1, wherein displaying a current portion of the entire tree view in the outliner view further comprises:
selecting an object in the outliner view to create an outliner view of the selected object; and
expanding the outliner view of the selected object to be an only structure in a legible form in the outliner view.

8. A data processing system for graphically navigating a tree structure, the data processing system comprising:
a bus;
a memory connected to the bus;
a display connected to the bus;
a communications unit connected to the bus;
a persistent storage connected to the bus, wherein the persistent storage having computer usable instructions tangibly embodied thereon;
a processor unit connected to the bus, wherein the processor unit executes the computer program instructions to:
create an outliner view of a tree view comprising the entire tree structure;
determine whether an object has been selected from the tree view to create a selected object;
respond to a determination that the object was selected and display the entire tree view and further displaying the selected object only in a legible form in the outliner view; otherwise, display a current portion of the entire tree view in the outliner view.

9. The data processing system of claim 8, wherein the processor unit executes the computer program instructions to display the entire tree view further comprises:
displaying a current portion of the entire tree view in the outliner view in the absence of the selected object.

10. The data processing system of claim 8, wherein the processor unit executes the computer program instructions to display the selected object further comprises:
highlighting the selected object.

11. The data processing system of claim 8, wherein the processor unit executes the computer program instructions to display the selected object further comprises:
displaying a path from the selected object to a parent of the selected object in a legible form in the outliner view.

12. The data processing system of claim 8, wherein the processor unit executes the computer program instructions to display a current portion of the entire tree view in the outliner view further comprises:
navigating within the entire tree view by moving a mouse pointer; and
expanding an object when a mouse pointer moves over the object to reveal hidden associated objects.

13. The data processing system of claim 8, wherein the processor unit executes the computer program instructions to display a current portion of the entire tree view in the outliner view further comprises:
displaying an object, when a mouse pointer moves over the object, in a legible form in the outliner view.

14. The data processing system of claim 8, wherein the processor unit executes the computer program instructions to display a current portion of the entire tree view in the outliner view further comprises:
selecting an object in the outliner view to create an outliner view selected object; and
expanding the outliner view selected object to be an only structure in a legible form in the outliner view.

15. A computer program product for graphically navigating tree structures, the computer program product comprising a computer usable recordable medium having computer usable program code tangibly embodied thereon, the computer usable program code comprising:
computer usable program code for creating an outliner view of a tree view comprising the entire tree structure;
computer usable program code for determining whether an object has been selected from the tree view to create a selected object;
computer usable program code responsive to an object being selected for displaying the entire tree view and further displaying the selected object only in a legible form in the outliner view; otherwise, displaying a current portion of the entire tree view in the outliner view.

16. The computer program product of claim 15, wherein the computer usable program code for displaying the selected object further comprises:
computer usable program code for highlighting the selected object.

17. The computer program product of claim 15, wherein the computer usable program code for displaying the selected object further comprises:
computer usable program code for displaying a path from the selected object to a parent of the selected object in a legible form in the outliner view.

18. The computer program product of claim 15, wherein the computer usable program code for displaying a current portion of the entire tree view in the outliner view further comprises:
computer usable program code for navigating within the entire tree view by moving a mouse pointer; and
computer usable program code for expanding an object when a mouse pointer moves over the object to reveal hidden associated objects.

19. The computer program product of claim 15, wherein the computer usable program code for displaying a current portion of the entire tree view in the outliner view further comprises:
computer usable program code for displaying an object, when a mouse pointer moves over the object, in a legible form in the outliner view.

20. The computer program product of claim 15, wherein the computer usable program code for displaying a current portion of the entire tree view in the outliner view further comprises:
computer usable program code for selecting an object in the outliner view to create an outliner view of the selected object; and
computer usable program code for expanding the outliner view of the selected object to be an only structure in a legible form in the outliner view.
